(19) United States
(12) Patent Application Publication
(10) Pub. No.: US 2016/0285753 A1
(43) Pub. Date: Sep. 29, 2016

(54) LOCK FREE FLOW LEARNING IN A NETWORK DEVICE

(71) Applicant: Telefonaktiebolaget L M Ericsson (publ), Stockholm (SE)

(72) Inventor: Vikram Guleria, Milpitas, CA (US)

(21) Appl. No.: 14/671,751

(22) Filed: Mar. 27, 2015

(51) Int. Cl. H04L 12/721; H04L 12/743

(52) U.S. Cl. CPC H04L 45/38; H04L 45/7453

(57) ABSTRACT

A method in a network device of flow learning in a network device are provided. The method comprises determining whether the flow of a packet is being learnt by the network device; in response to determining that the flow is already being learnt, forwarding the packet without sending a request to insert a new entry in one of the set of one or more forwarding tables; and in response to determining that the flow is not yet being learnt, performing: 1) updating a retrieved flow learning element to include a second portion of a flow identification, 2) sending a request to store the updated flow learning element into a flow learning table, and 3) in response to determining that the updated flow learning element is stored, sending a request to insert a new entry associated with the flow of the packet in a forwarding table.

### FIELD

Embodiments of the invention relate to the field of computer networking; and more specifically, to flow learning in a networking system.

### BACKGROUND

Software-defined networks (SDN) present many advantages over traditional monolithic architecture networks. For example, the control plane applications that implement important network routing and switching functionalities are completely separated from the forwarding plane. Thus, maintaining a centralized control plane enables highly customized and optimized networking services that can be tailored to specific user needs. A centralized control plane provides a highly scalable, reliable, and flexible networking infrastructure that can cater to diverse user needs. The forwarding plane (or data plane) devices can be inexpensive and interchangeable commodity networking devices, which reduces the overall configuration and maintenance burdens for the user. Additionally, a single management and configuration entity for the entire network enhances the ease-of-use experience for users.

However, current SDN configurations also suffer from shortcomings A problem exists in that different or novel traffic received at the forwarding plane cannot be processed until the control plane provides the forwarding device with instructions for that traffic. Accordingly, when packets of a new traffic flow first enter a SDN, these initial packets are unable to be forwarded until the control plane has provided the forwarding devices within the SDN with forwarding instructions for the flow. Further, to enable the control plane to decide what to do with these initial packets of a new flow, the packets are typically transmitted by the forwarding devices to the control plane. In SDNs employing many forwarding devices in the forwarding plane that may receive many such “unknown” packets, such packet transmission to the control plane can overwhelm the network and control plane with traffic.

### SUMMARY

Embodiments of the present invention overcome the limitations of the conventional solutions to the above described problem by providing techniques for lock free flow learning in a network device. Embodiments of the present invention provides techniques which avoid sending multiple requests to the control plane in order to learn the same flow and to avoid delays in the processing of new flow entries. Embodiments of the invention provides methods and network devices to send a single insertion request to the control plane for adding a new flow to a set of forwarding tables. In embodiments of the invention, all duplicate flow insertion requests are dropped and are not sent to the control plane. Embodiments of the invention provide methods and devices for flow learning without taking any synchronization locks so it has minimum impact on the performance of the networking device.

A method of flow learning in a network device is described. The method comprises receiving, by the network device, a packet of a flow of packets; determining, based on an identification of the flow of the packet, whether the packet has a corresponding forwarding table entry within a set of one or more forwarding tables of the network device. The method continues in response to determining that the packet does not have any corresponding forwarding table entry, retrieving a flow learning element from a flow learning table using a first portion of the flow identification; determining whether the flow of the packet is being learnt by the network device, based at least on a second portion of the flow identification for the received packet matching a sub-element of the retrieved flow learning element; responsive to determining that the flow is being learnt, forwarding the packet without sending a request to insert a new entry in one of the set of one or more forwarding tables; and responsive to determining that the flow is not yet being learnt, performing the following: updating the retrieved flow learning element to include the second portion of the flow identification, sending a request to store the updated flow learning element into the flow learning table, and responsive to determining that the updated flow learning element is stored in the flow learning table, sending a request to insert a new entry associated with the flow of the packet in a forwarding table from the set of one or more forwarding tables.

A non-transitory machine-readable storage medium that provides instructions, which when executed by a processor of a network device, cause said processor to perform operations comprising: receiving, by the network device, a packet of a flow of packets; determining, based on an identification of the flow, whether the packet has a corresponding forwarding table entry within a set of one or more forwarding tables of the network device. The operations further comprise responsive to determining that the packet does not have any corresponding forwarding table entry, retrieving a flow learning element from a flow learning table using a first portion of the flow identification; determining whether the flow of the packet is being learnt by the network device, based at least on a second portion of the flow identification for the received packet matching a sub-element of the retrieved flow learning element; responsive to determining that the flow is being learnt, forwarding the packet without sending a request to insert a new entry in one of the set of one or more forwarding tables; and responsive to determining that the flow is not yet being learnt performing the following: updating the retrieved flow learning element to include the second portion of the flow identification, sending a request to store the updated flow learning element into the flow learning table, and responsive to determining that the updated flow learning element is stored in the flow learning table, sending a request to insert a new entry associated with the flow of the packet in a forwarding table from the set of one or more forwarding tables.

### BRIEF DESCRIPTION OF THE DRAWINGS

The invention may best be understood by referring to the following description and accompanying drawings that are used to illustrate embodiments of the invention. In the drawings:

FIG. 1 illustrates a block diagram of a networking system with lock free flow learning according to embodiments of the invention.

FIG. 2 illustrates a flow diagram of flow learning in a network device according to some embodiments of the invention.

FIG. 3 illustrates a flow diagram of operations performed when the flow of an unknown packet is not being learnt yet according to some embodiments of the invention.

FIG. 4 illustrates a flow diagram of operations performed to update of a flow learning element associated with an unknown packet according to some embodiments of the invention.

FIG. 5 illustrates a block diagram of a flow learning element as retrieved from a flow learning table according to some embodiments of the invention.

FIG. 6A illustrates connectivity between network devices (NDs) within an exemplary network, as well as three exemplary implementations of the NDs, according to some embodiments of the invention.

FIG. 6B illustrates an exemplary way to implement a special-purpose network device according to some embodiments of the invention.

FIG. 6C illustrates various exemplary ways in which virtual network elements (VNEs) may be coupled according to some embodiments of the invention.

FIG. 6D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 6E illustrates the simple case of where each of the NDs implements a single NE, but a centralized control plane has abstracted multiple of the NEs in different NDs into (to represent) a single NE in one of the virtual network(s), according to some embodiments of the invention.

FIG. 6F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 7 illustrates a general purpose control plane device with centralized control plane (CCP) software 750), according to some embodiments of the invention.

### DESCRIPTION OF EMBODIMENTS

The following description describes methods and apparatus for flow learning in a network element. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Challenges of Flow Learning in a Network Device

In an embodiment, a forwarding element is a flow switching enabled network device. The flow switching enabled network device forwards packets based on the flow each packet belongs to instead of the destination IP address within the packet, which is typically used in current conventional packet switched IP networks. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers.

The control plane transmits relevant messages to a forwarding element based on application layer calculations and middleware layer mapping for each flow. The forwarding element processes these messages and programs the appropriate flow information and the corresponding actions in its forwarding tables. The forwarding element maps packets to flows and forwards packets based on these forwarding tables. Of course, forwarding tables may be implemented in a variety of data structures, such as maps, lists, arrays, files, tables, relational databases, etc. Further, the discussion of columns and rows within these tables is arbitrary; while one implementation may choose to put entries in rows it is trivial to modify the data structure to put entries in columns instead.

Standards for flow processing define the protocols used to transport messages between the control and the forwarding plane and describe the model for the processing of packets. This model for processing packets in flow processing devices includes header parsing, packet classification, and making forwarding decisions.

Header parsing describes how to interpret the packet based upon a well-known set of protocols (e.g., Ethernet, virtual local area network (VLAN), multiprotocol label switching (MPLS), IPv4, etc.). Some layers of headers contain fields including information about how to de-multiplex the next header. For example, an Ethernet header includes a field describing what type of header is in the next layer. Some protocol fields may be used to build a match structure (or key) that will be used in packet classification/mapping. For example, a first key field could be a source media access control (MAC) address, and a second key field could be a destination MAC address.

Packet classification involves executing a lookup in memory to classify the packet by determining which flow entry in the forwarding tables best matches the packet based upon the match structure, or key, of the flow entries. It is possible that many flows can correspond to a packet; in this case the system is typically configured to determine one flow from the many flows according to a defined scheme (e.g. selecting a first flow entry that is matched).

Making forwarding decisions and performing actions occurs based on the flow entry identified in the previous step of packet classification by executing actions using the packet. Each flow in the forwarding table is associated with a set of actions to be executed for each corresponding packet. For example, an action may be to push a header onto the packet, forward the packet using a particular port, flood the packet, or simply drop the packet. In some embodiments packet classification and the execution of forwarding decisions is performed with a set of one or more packet processing threads through which the packets received at the network device are distributed. In one embodiment, each packet processing thread runs on a different processor core. In an alternative embodiment, two or more packet processing threads may run on a single processor core.

However, when an unknown packet (sometimes referred to as a “missed packet” or a “match-miss” as used in OpenFlow parlance) arrives at the data plane (e.g., at a forwarding device including a forwarding element), the packet—or a subset of the packet header and content—is typically forwarded to the control plane (or controller) to be learnt. The controller, which executes software that defines a process for deciding how to handle packets and program corresponding entries in the data-plane, will then program forwarding table entries (also known as flow entries) into forwarding devices in the data plane to accommodate packets belonging to the flow of the unknown packet.

Among other pieces of information, programmed forwarding table entries define both a specific set of match criteria (a set of values or wildcards, or an indication of what portions of a packet should be compared to a particular value/values/wildcards, as defined by the data plane's matching capabilities—i.e. —for specific fields in the packet header, or for some other packet content), and an action or set of actions for the data plane to take on receiving a matching packet. Once a specific forwarding table entry has been programmed by the control plane, when a next packet with matching credentials arrives, it matches the created entry in the data plane and the forwarding element takes the action associated with the matched entry. The process of learning an unknown packet received at the forwarding element may be referred to as flow learning.

With high volume of traffic handled by the forwarding device, a high number of unknown packets may be received at the same time at the forwarding device. Upon receipt of these packets, multiple packets of the same flow may be distributed over different packet processing threads of the forwarding device. Thus, multiple unknown packets of the same flow can get assigned to different packet processing threads at substantially the same time. A request is then sent to the control plane to insert an entry corresponding to the flow in a forwarding table for each unknown packet being processed in a packet processing thread. Until the moment the flow corresponding to the unknown packets is learnt and a forwarding table entry is created in the set of forwarding tables of the forwarding device, there could be a very high number of packets received for this flow which needs to be processed. This results into multiple insertion requests being sent to the control plane (or to a background control table thread in the control plane device). However, duplicate insertion requests can bring down the rate at which new flows can be learnt.

In one approach, thread synchronization locks are used to handle duplicate insertion requests sent from multiple packet processing threads. However, taking thread synchronization locks on a highly threaded processor such as the forwarding element (which may include hundreds or thousands of packet processing threads), can significantly decrease the learning rate at which new flows are learnt and added to the set of forwarding tables of the forwarding element.

Another approach is to add an entry in a packet miss table at the packet forwarding element for each new flow. The miss packet table is then accessed by the control plane, at its own rate (independent of data plane processing), in order to pull an entry. The control plane processes the entry, and creates an entry (or multiple entries) in the set of forwarding tables. This approach delays the learning of a new flow, as packets of a new flow may not be forwarded properly until the flow is learnt and inserted in the forwarding table, and as the new flow is learnt at a rate determined by the control plane.

Lock Free Flow Learning

Embodiments of the present invention overcome the limitations of the conventional solutions to the above described problem by providing techniques for lock free flow learning in a network device. Embodiments of the present invention provides techniques which avoid sending multiple requests to the control plane in order to learn the same flow and to avoid delays in the processing of new flow entries. Embodiments of the invention provides methods and network devices to send a single insertion request to the control plane for adding a new flow to a set of forwarding tables. In embodiments of the invention, all duplicate flow insertion requests are dropped and are not sent to the control plane. Embodiments of the invention provide methods and devices for flow learning without taking any synchronization locks so it has minimum impact on the performance of the networking device.

According to one embodiment, a method of flow learning in a network device is provided. Upon receipt of a packet of a flow of packets at the network device, it is determined, based on an identification of the flow, whether the packet has a corresponding forwarding table entry within a set of one or more forwarding tables of the network device. If the packet is determined not to have any corresponding forwarding table entry (i.e., the packet belongs to an unknown flow, which is to be inserted in a forwarding table), a flow learning element is retrieved from a flow learning table using a first portion of the flow identification. A second portion of the flow identification for the received packet is used to determine whether the flow of the packet is currently being learnt. In response to determining that the second portion matches a sub-element of the retrieved flow learning element (i.e., the flow is already being learnt), the packet is forwarded without sending a request to insert a new entry in one of the set of one or more forwarding tables. Alternatively, in response to determining that the second portion of the flow identification for the received packet does not match a sub-element of the retrieved flow learning element (i.e., the flow is not being learnt yet) performing a set of the following operations: 1) updating the retrieved flow learning element to include the second portion of the flow identification, 2) sending a request to store the updated flow learning element into the flow learning table, and 3) responsive to determining that the updated flow learning element is stored in the flow learning table, sending a request to insert a new entry associated with the flow of the packet in a forwarding table from the set of one or more forwarding tables.

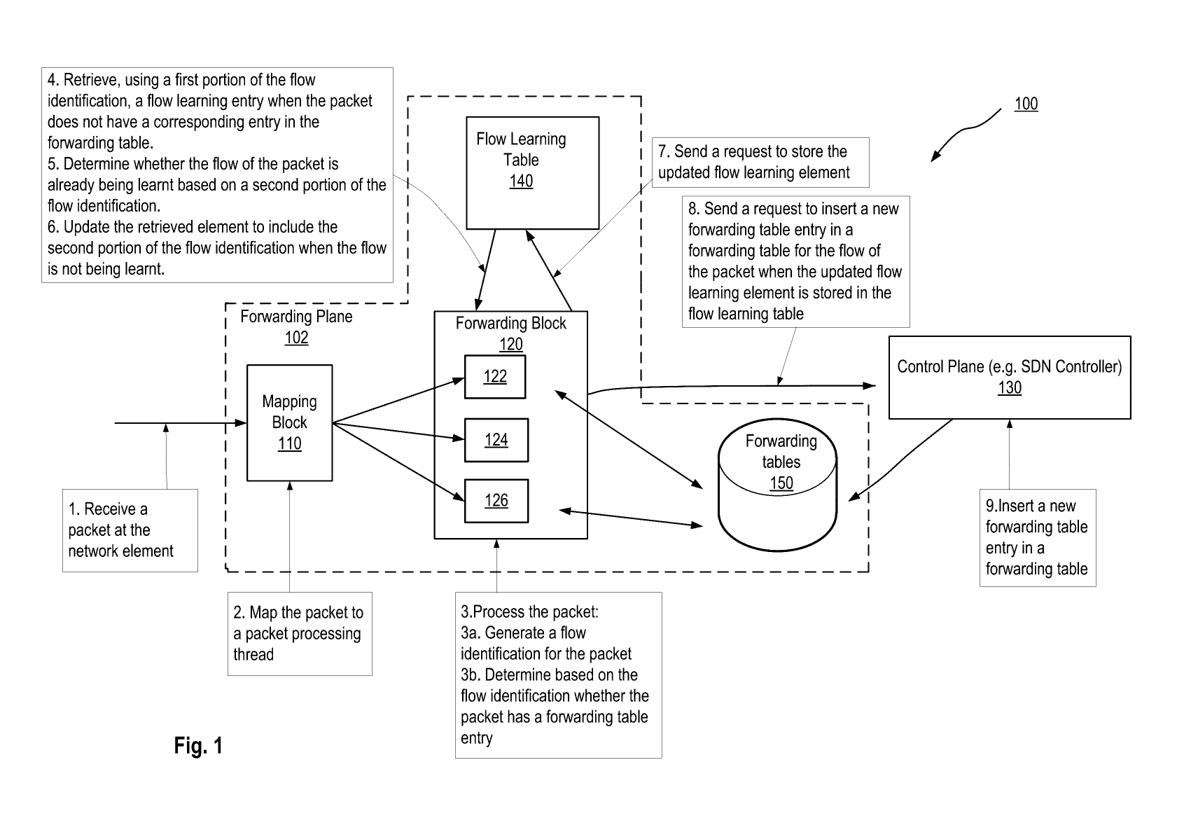

FIG. 1 illustrates a block diagram of a networking system with lock free flow learning according to one embodiment. In the illustrated example, the networking system 100 includes a forwarding plane 102 (also referred to herein below as the forwarding element) coupled with a control plane 130. The control plane 130 comprises compute resource(s) that execute control communication and configuration module(s). The forwarding plane 102 (sometimes referred to as a data plane, or a media plane) comprises forwarding resource(s) that utilize the forwarding table(s) 150 to forward packets received on physical interfaces (not shown in FIG. 1). In one embodiment, the forwarding plane 102 is comprised in a first network device, while the control plane 130 is included in a second network device coupled with the first network device. In an alternative embodiment, the forwarding plane 102 and the control plane 130 are both comprised in the same network device.

By way of example, where the network system is a router (or is implementing routing functionality), the control plane 130 is typically responsible for participating in controlling how data (e.g., packets) is to be routed (e.g., the next hop for the data and the outgoing physical NI for that data) and storing that routing information in the forwarding table(s) 150, and the forwarding plane 102 is responsible for receiving that data and forwarding that data out the appropriate ones of physical network interfaces based on the forwarding table(s) 150. In another example, the network system is a bridge.

In one embodiment, the forwarding plane 102 includes a network element configured or adapted to include a mapping block 110, a forwarding block 120, a flow learning table 140, and a set of one or more forwarding tables 150 coupled with the forwarding block 120. The forwarding block 120 includes a set of one or more packet processing threads 122, 124, and 126. Although only three packet processing threads are illustrated, any number of packet processing threads can be present in the forwarding block 120 (e.g., typically hundreds or thousands of packet processing threads are included in the forwarding block 120). Task boxes 1 to 9 illustrate the order in which operations are performed according to one embodiment of the invention.

At task box 1, a packet of a flow is received at the network device including the forwarding plane 102. The packet is received through a network interface and forwarded to the mapping block 110. At task box 2, the mapping block 110 maps the packet to one of the packet processing threads 122/124/126 of the forwarding block 120 (e.g., the packet is mapped to the packet processing thread 122). In one embodiment, the mapping block 110 maps a packet to a packet processing thread according to a Round-Robin mechanism, a random distribution mechanism, or another distribution mechanism which may take additional factors into account (e.g., heuristics, current workloads of each packet processing thread, queue lengths at the packet processing threads, etc.). While three packet processing threads 122/124/126 are illustrated in FIG. 1, alternative embodiments of the invention could have any number of packet processing threads.

At task box 3, the packet is processed in the mapped packet processing thread. In one example, the packet received at the network element 102 is mapped to the packet processing thread 122. The packet processing thread 122 performs classification and forwarding of the packet according to a corresponding entry in the set of forwarding table(s) 150 such that it is dropped or output to the appropriate physical network interfaces (NIs). In one embodiment, at task box 3a, the packet processing thread 122 generates an identification of the flow corresponding to the packet being processed. In one embodiment, the identification of the flow (also referred herein as “flow identification”) is generated based on a key associated with the flow of the packet. In one embodiment, the key associated with the flow is a series of bits from the headers of the packet. As described previously the packets of a same flow have headers that match a given pattern of bits. In some embodiments, the key from which the identification of the flow is generated is the given pattern of bits or alternatively a subset of bits from the given pattern of bits. Some protocol fields may be used to build the key (or match structure) that will be used in packet classification/mapping by the packet processing thread. For example, a first key field could be a source media access control (MAC) address, and a second key field could be a destination MAC address. Alternatively or in addition, other fields may be used (e.g., bits corresponding to header fields such as IP destination address, IP source address, protocol and/or UDP/TCP/SCTP port numbers used by the application, VLAN IDs, etc. . . . ). In some embodiments the flow identification for the packet is calculated as a hash value based on the key associated with the flow. All packets with the same hash result are associated with the same flow and handled in the same way. In a non-limiting exemplary embodiment, the hash function used to generate the flow identification is a cyclic redundancy check (CRC) flow hash (e.g., CRC-32, CRC-64, CRC-16, or CRC-8).

At task box 3b, the packet processing thread 122, determines based on the flow identification (generated at task box 3a), whether the packet has a corresponding forwarding table entry within the set of one or more forwarding table(s) 150. This task may be referred to as packet classification, and involves executing a lookup in memory to classify the packet by determining which forwarding table entry in the forwarding tables 150 best matches the packet based upon the match structure, or key, of the forwarding table entries. It is possible that many flows can correspond to a packet; in this case the system is typically configured to determine one flow from the many flows according to a defined scheme (e.g. selecting a first flow entry that is matched).

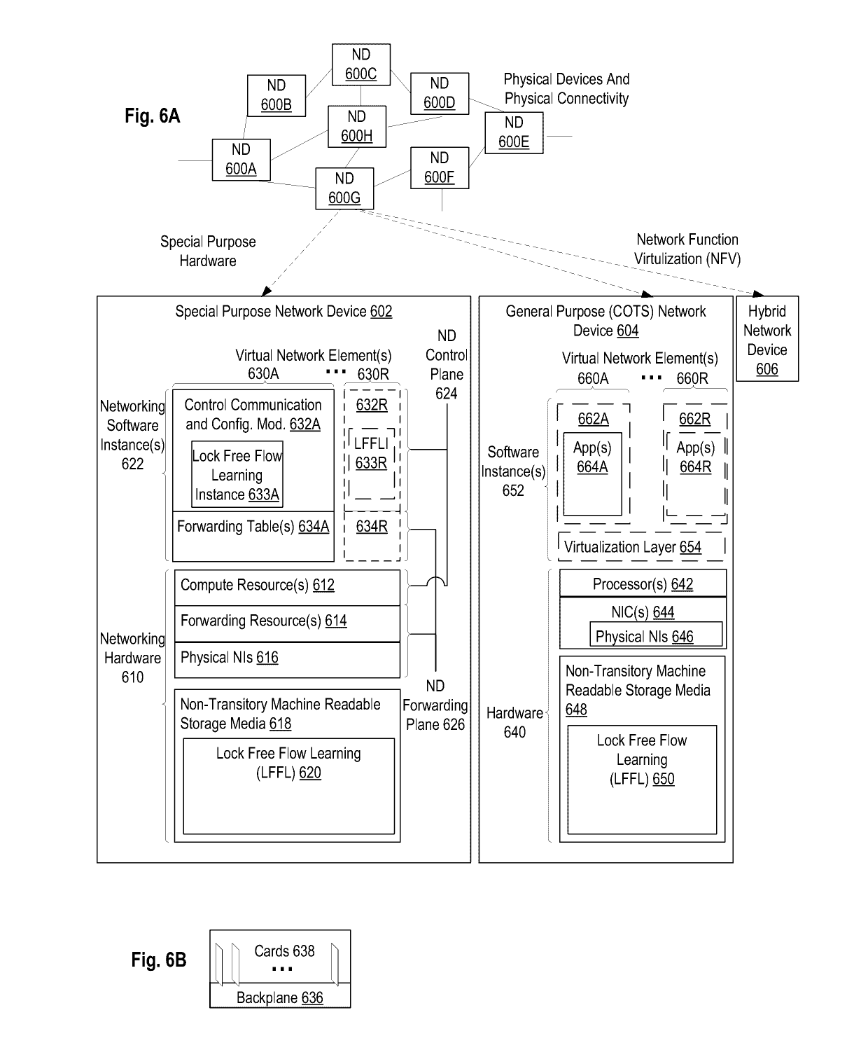

At task box 4, responsive to determining that the packet does not have any corresponding forwarding table entry within the set of forwarding tables 150 of the network (i.e., that the packet is unknown or sometimes, as used in OpenFlow parlance, that it is a “missed packet” or a “match-miss”), a flow learning entry is retrieved from a flow learning table based on a first portion of the flow identification of the packet. When the packet does not have any corresponding forwarding table entries (i.e., the flow corresponding to the packet is to be learnt), a portion of the flow identification is used to access an entry in the flow learning table. The flow learning table is a learn cache stored in the local memory of the network device including the unknown flows that are in the process of being learnt by the network device. The portion of the flow identification is referred to as the learn hash bits and are used to get to a learn table element. In one embodiment, when the flow identification is computed with a hash function of a key associated with the packet (e.g., CRC-32), a portion of the hash value (flow identification) is used to access the learn table. In a non-limiting example, the flow identification (e.g., a hash value computed with CRC-32) is 32 bits hash value, and 8 bits of these 32 bits are used to access the learn table element. FIG. 5, illustrates a block diagram of a flow learning element 520 as retrieved from the flow learning table 500. The flow learning element 520 is retrieved by the packet processing thread (e.g., 122/124/126) to be stored in a cache memory of the packet processing thread. In one embodiment, the packet processing thread 122, fetches N bytes of data (element 520 of FIG. 5) from the flow learning table 500 (e.g., a 32 bytes fetch command is performed) and stores the retrieved flow learning element (520) into a cache memory (e.g., scratchpad (SPAD) memory) of the packet processing thread 126.

In some embodiments, another packet processing thread (e.g., packet processing thread 126) of the forwarding block 120 may be processing another packet belonging to the same flow as the packet being processed in the packet processing thread 122. As this other packet belongs to the same flow, and is processed at substantially the same time as the packet processed in packet processing thread 122, this packet may also be determined to be unknown and the packet processing thread 126 uses the same portion of the flow identification associated with the packet to access an element of the flow learning table. In this embodiment, the same element is therefore retrieved by two separate packet processing threads (e.g., 122 and 126) of the forwarding block 120. Similarly to the packet processing thread 122, the packet processing thread 126 fetches N bytes (element 520 of FIG. 5) from the flow learning table 500 (e.g., a 32 bytes fetch command is performed) and stores the retrieved element into a cache memory of the packet processing thread 126.

In one embodiment, the element 520 when retrieved from the flow learning table 500 by the packet processing thread 126 is identical to the copy made by the packet processing thread 122 when processing the other packet. In an alternative embodiment, the element 520 when retrieved from the flow learning table 500 by the packet processing thread 126 has been modified after being retrieved by the packet processing thread 122 (i.e., either by the packet processing thread 122 or by another packet processing thread from the forwarding block 120), and the element stored in the cache memory of the packet processing thread 126 is different from the element stored in the cache of the packet processing thread 122.

At task box 5, the packet processing thread 122 determines whether the flow of the unknown packet being processed is already being learnt at the forwarding element 102 based at least on a second portion of the flow identification matching a sub-element of the retrieved flow learning entry. As illustrated in FIG. 5, according to one embodiment, the flow learning element 520 retrieved at task box 4, includes a set of two or more sub-elements. In one embodiment, the flow learning element 520 includes flow slots 522, flow pointers 524 and queue identifier 526. In some embodiments, the queue identifier 526 is optional and may not be included in the flow learning element 520. In other embodiments the queue identifier 526 identifies the queue of a background control queue of the control plane 130 which will receive a request to learn the new flow. In one embodiment, the flow slots 522 includes a set of one or more (M) slots (e.g., 4 slots) of sub-elements (e.g., reference 522A and reference 522B). Each of the slots (e.g., slot 522A) includes two parts, i.e. two sub-elements: sub-element 532 and sub-element 534. The first sub-element 532 includes an indication of whether the slot is free or used. In one embodiment, the sub-element is one bit (0 or 1) indicating that the slot 522A is being used by a flow that is currently being learnt at the forwarding device. In a non-limiting example, if the slot has already been used to store a flow identification of a packet being learnt, the 532 sub-element is set to 1. If the slot has not been used to store a flow identification of a packet being learnt, the 532 sub-element is set 0. In an alternative embodiment, 0 and 1 may be used to indicate the opposite (i.e., if a flow is being learnt, the bit is set to 0; if the flow is not being learnt, the bit is set to 1). The second sub-element 534 includes a number of bits used to store an identification of a flow being learnt. In one embodiment, the sub-element 534 includes a portion of the flow identification of the packet.

In some embodiments, the retrieved element 520 includes additional sub-elements such as a set of one or more (e.g., M) flow pointers 524 and queue identifier 526. In one embodiment, the element 520 includes for each sub-element (flow slot) 522 a corresponding flow pointer 524 comprising a pointer to a location in memory to be reserved for the addition of a new forwarding table entry in the forwarding table 150 corresponding with the flow of packets.

Referring back to task box 5, upon retrieval of the element 520, the packet processing threads (e.g., 122 or 126) determines whether the flow of unknown packet being processed is already being learnt at the forwarding device based at least on whether the sub-element 534 matching a portion of the flow identification of the packet. The packet processing thread evaluate each slot in the flow learning element 520 which has a “used” bit set to determine if the flow of the packet is being learnt. In this embodiment, the packet processing thread does not evaluate or look up the slots which has a “free” bit set. In an alternative embodiment, the packet processing thread evaluates all sub-elements of the flow learning element 520 to determine whether the flow is being learnt.

In one embodiment, when the flow identification is computed with a hash function of a key associated with the packet (e.g., CRC-32), a first portion of the hash value (flow identification) is used to access the learn table and retrieve element 520 and a second portion of the hash value (flow identification) is compared with the sub-element 534 of the used slots. In a non-limiting example, the flow identification (e.g., a hash value computed with CRC-32) is 32 bits hash value, and 8 bits of these 32 bits are used to access the learn table element and 15 bits of the hash value are compared with the sub-element 534. In one embodiment, the second portion of the flow identification (e.g., 15 bits of the flow hash) is compared with each sub-element of the element 520 which has been marked as used to determine whether the flow corresponding to the packet being processed is already being learnt by the forwarding device or not. If the bits match, then either the flow is already being learnt, or the first portion of the flow identification (e.g., the first 8 bits of the CRC-32 of the packet) and the second portion of the flow identification (e.g., the following 15 bits of the CRC-32 of the packet) match with the first and second portion of another flow. However the chances of collision are very rare (i.e., the chances that the first and second portion of the flow identification of two packets belonging to two different flows collide are very rare). In one embodiment, where N is the number of flow learning elements in the flow learning table, and N is 256. In one example, 8 bits, of the hash value(flow identification) generated for a packet, are used to access an element in the flow learning tables, and 15 bits from the hash value are used to determine whether the flow learning element includes the flow identification. In this example, 23 bits in total of the flow identification are used to identify the flow to which the packet belongs. Thus, chances of 256 elements to collide in 23 bits of hash are almost impossible. Given this assumption, when the first portion of the flow identification and the second portion of the flow identification match (e.g., the first 8 bits and the following 15 bits), the packet processing thread determines that the flow is already being learnt. Alternatively if the second portion of the flow identification does not match any sub-element of the flow learning element 520 which has a “used” bit set, this means that the flow is not being learnt by the forwarding device and an entry needs to be inserted in the flow learning table 500.

At task box 6, when the packet processing thread determines that the flow of the packet is not being learnt (i.e., the flow identification is not in the flow learning table), the flow learning element 522 is updated to include the second portion of the flow identification in the cache memory of the packet processing thread. In one embodiment, a “free” slot (i.e., a slot with a free bit set (e.g., bit 532 is set to 0) is selected in the flow learning element stored in the cache memory of the packet processing thread. The slot is marked used (e.g., bit 532 is set to 1), and 15 bits of the flow identification of the packet are stored in the sub-element 534 of the flow learning element.

At task box 7, a request is sent to store the updated element in the flow learning table 500. In one embodiment, the packet processing thread 122 (or 126) attempts to update the element in the flow learning table by reserving a slot using a compare and swap instruction (e.g., a 64 bits compare and swap instruction “mopcas1qs”). If the packet processing thread succeeds in reserving the slot and adding the updated flow learning element to the flow learning table. The packet processing thread may use the flow pointer fetched in fetch 32. Else the process is repeated to find, and reserve a free slot. If free slot is reserved, another memory access is performed to get the flow pointer corresponding to reserved slot. In some embodiments, no free slot may be found, and the unknown flow is not learnt. However, as long as the control plane processes the requests to insert unknown flows in the forwarding table(s) the number of elements in the flow learning table should be less than N and free slots for new unknown flows should be found.

In some embodiments, if two packet processing threads (e.g., packet processing thread 122 and 126) attempt to update the same element 520 in the flow learning table, only one will succeed in inserting the element as a consequence of the compare and swap instruction. In other words a new element can only be added to the table if it is not already there. This allows the processing of unknown packets by two or more different packet processing thread lock free, such that only one request is sent to the control plane for an unknown packet without having to stall the processing within the forwarding block 120.

At task box 8, a request is sent to insert a new forwarding table entry in a forwarding table for the flow associated with the packet when the updated flow learning element is stored in the flow learning table. The control plane 130 receives a request to insert a new forwarding entry associated with the unknown packet. When the control table thread is done inserting the flow in the forwarding table(s) 150, the flow is removed from the flow learning table. In one embodiment the flow is removed from the flow learning table by making its corresponding slot available. For example, the bit 532 associated with the second portion of flow identification 534 is set to 0. Further, the flow's slot index (e.g., 522A) in the flow learning table is sent in the request sent to the control plane. A new flow is allocated, and the flow pointer is set to the flow's slot, followed by a fence. At task box 9, the control plane inserts a new forwarding table entry in the forwarding tables 150.

In some embodiments, once the flow is added to one or more forwarding tables 150, it is removed from the flow learning table 140. However, in some embodiments, there may be packets of the same unknown flow that have gone past the forwarding table lookup stage in the forwarding block and which did not find their corresponding flow in any of the forwarding tables, but their processing in the forwarding block is not complete yet. Thus, if the flow learning entry corresponding to this flow is removed from the flow learning table 140, such packets may be added to the learning table 140 and may result in sending one more flow learning request to the control plane. In one embodiment, the request is dropped by the control plane 130. In an alternative embodiment, before removing the flow from the flow learning table, the forwarding element waits for all packets that were received before the flow is visible in the forwarding tables, to complete their packet processing. In this embodiment, a next packet of the same flow received at the network element will be processed according to the new entry in the one or more forwarding tables.

Even though the tasks of the task boxes 1-9 are described in a sequential order, some tasks may be performed concurrently or in a different order than described above. In other embodiments, additional or fewer tasks may be performed.

The operations in the flow diagrams will be described with reference to the exemplary embodiments of FIGS. 1 and 5. However, it should be understood that the operations of the flow diagrams can be performed by embodiments of the invention other than those discussed with reference to FIGS. 1 and 5, and the embodiments of the invention discussed with reference to these other figures can perform operations different than those discussed with reference to the flow diagrams.

Flow Diagrams of Lock Free Flow Learning

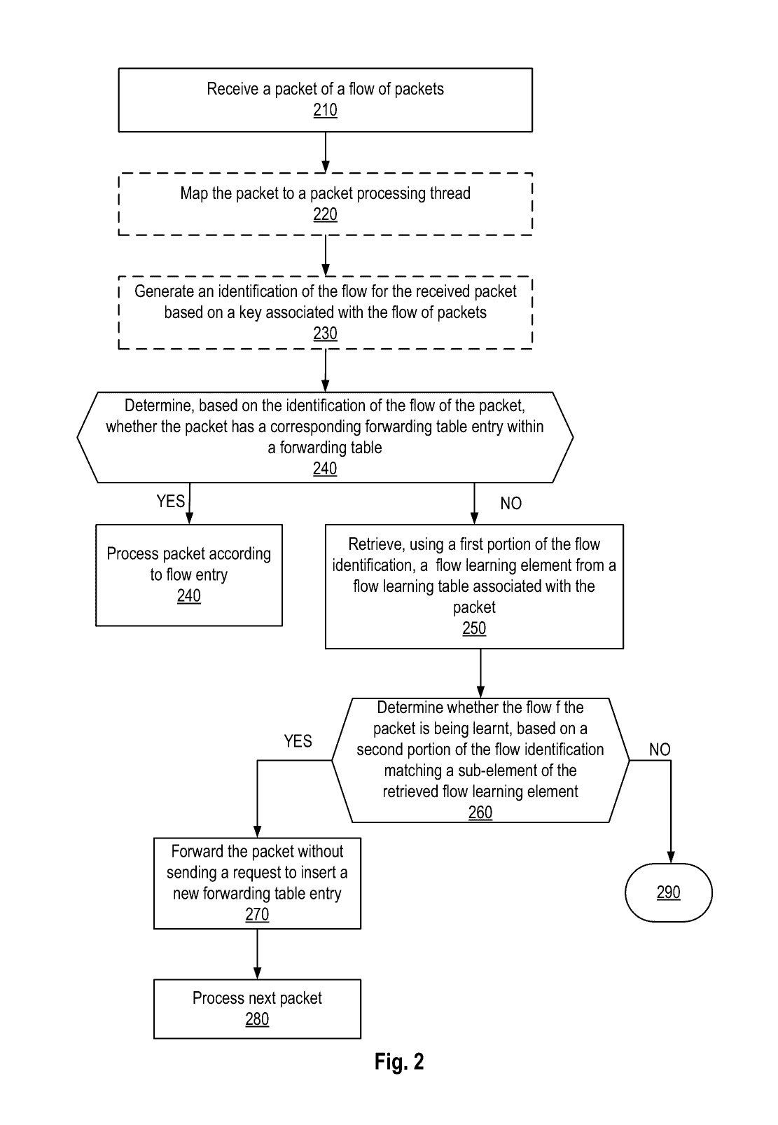

FIG. 2 illustrates a flow diagram of flow learning in a network device according to embodiments of the invention.

At block 210, a packet of a flow is received at the network device including the forwarding plane 102. The packet is received through a network interface (not shown) and forwarded to the mapping block 110. At block 220, the mapping block 110 maps the packet to one of the packet processing threads 122/124/126 of the forwarding block 120 (e.g., the packet is mapped to the packet processing thread 122). In one embodiment, the mapping block 110 maps a packet to a packet processing thread according to a Round-Robin mechanism, a random distribution mechanism, or another distribution mechanism which may take additional factors into account (e.g., heuristics, current workloads of each packet processing thread, queue lengths at the packet processing threads, etc.). While three packet processing threads 122/124/126 are illustrated in FIG. 1, alternative embodiments of the invention could have any number of packet processing threads.

In one example, the packet received at the network device is mapped to the packet processing thread 122 which processes the packet. The packet processing thread 122 performs, classification and forwarding of the packet according to a corresponding entry in the set of forwarding table(s) 150 such that it is dropped or output to the appropriate physical network interfaces (NIs). In one embodiment, at block 230, the packet processing thread 122 generates an identification of the flow of the packet. In one embodiment, the identification of the flow (also referred herein as “flow identification”) is generated based on a key associated with the flow of corresponding to the packet being processed. In one embodiment, the key associated with the flow of packets is a series of bits from the headers of the packet. As described previously the packets of a same flow have headers that match a given pattern of bits. In some embodiments, the key from which the identification of the flow is generated is the given pattern of bits or alternatively a subset of bits from the given pattern of bits. Some protocol fields may be used to build the key (or match structure) that will be used in packet classification/mapping by the packet processing thread. For example, a first key field could be a source media access control (MAC) address, and a second key field could be a destination MAC address. Alternatively or in addition, other fields may be used (e.g., bits corresponding to header fields such as IP destination address, IP source address, protocol and/or UDP/TCP/SCTP port numbers used by the application, VLAN IDs, etc. . . . ). In some embodiments the flow identification for the packet is calculated as a hash value based on the key associated with the flow (e.g., where the key is a value of specified header information). All packets with the same hash result are associated with the same flow and handled in the same way. In a non-limiting exemplary embodiment, the hash function used to generate the flow identification is a cyclic redundancy check (CRC) flow hash (e.g., CRC-32, CRC-64, CRC-16, or CRC-8).

At block 240, the packet processing thread 122, determines based on the flow identification (generated at block 230), whether the packet has a corresponding forwarding table entry within the set of one or more forwarding table(s) 150. This task may be referred to as packet classification, and involves executing a lookup in memory to classify the packet by determining which forwarding table entry in the forwarding tables 150 best matches the packet based upon the match structure, or key, of the forwarding table entries. It is possible that many flows can correspond to a packet; in this case the system is typically configured to determine one flow from the many flows according to a defined scheme (e.g. selecting a first flow entry that is matched).

Responsive to determining that the packet has a corresponding forwarding table entry within the set of forwarding tables 150, flow moves to block 240 where the packet is forwarded by the network device according to the entry.

Responsive to determining that the packet does not have any corresponding forwarding table entry within the set of forwarding tables 150 of the network (i.e., that the packet is unknown or sometimes, as used in OpenFlow parlance, that it is a “missed packet” or a “match-miss”), flow moves to block 250. At block 250, a flow learning entry is retrieved from a flow learning table using a first portion of the flow identification of the packet. When the packet does not have any corresponding forwarding table entries (i.e., the flow corresponding to the packet is to be learnt), a portion of the flow identification is used to access an entry in the flow learning table. The flow learning table is a learn cache stored in the local memory of the network device including the unknown flows that are in the process of being learnt by the network device. The portion of the flow identification is referred to as the learn hash bits and are used to get to a learn table element. In one embodiment, when the flow identification is computed with a hash function of a key associated with the packet (e.g., CRC-32), a portion of the hash value (flow identification) is used to access the learn table. In a non-limiting example, the flow identification (e.g., a hash value computed with CRC-32) is 32 bits hash value, and 8 bits of these 32 bits are used to access the learn table element. As illustrated at FIG. 5, a flow learning element 520 is accessed in the flow learning table 500 and retrieved by the packet processing thread to be stored in a cache memory. In one embodiment, the packet processing thread 122, fetches N bytes of data (element 520 of FIG. 5) from the flow learning table 500 (e.g., a 32 bytes fetch command is performed) and stores the retrieved flow learning element (520) into a cache memory (e.g., scratchpad (SPAD) memory) of the packet processing thread 126.

In some embodiments, at least one other packet processing thread (e.g., packet processing thread 126) of the forwarding block 120 may receive and may be processing another packet belonging to the same flow as the packet being processed in the packet processing thread 122. As this other packet belongs to the same flow, and is processed at substantially the same time as the packet processed in packet processing thread 122, this packet may also be determined to be unknown and the packet processing thread 126 uses the same portion of the flow identification associated with the packet to access an element of the flow learning table. In this embodiment, the same element is therefore retrieved by two separate packet processing threads (e.g., 122 and 126) of the forwarding block 120. Similarly to the packet processing thread 122, the packet processing thread 126 fetches N bytes (element 520 of FIG. 5) from the flow learning table 500 (e.g., a 32 bytes fetch command is performed) and stores the retrieved element into a cache memory of the packet processing thread 126.

In one embodiment, the element 520 when retrieved (i.e., copied to the cache memory of thread 126) from the flow learning table 500 by the packet processing thread 126 is identical to the copy made by the packet processing thread 122 when processing the other packet. In an alternative embodiment, the element 520 when retrieved from the flow learning table 500 by the packet processing thread 126 has been modified after being retrieved by the packet processing thread 122 (i.e., either by the packet processing thread 122 or by another packet processing thread from the forwarding block 120), and the element stored in the cache memory of the packet processing thread 126 is different from the element stored in the cache of the packet processing thread 122. Flow then moves to block 260.

At block 260, the packet processing thread 122 determines whether the flow of the unknown packet being processed is already being learnt at the forwarding device based at least on a second portion of the flow identification matching a sub-element of the retrieved flow learning entry. As illustrated in FIG. 5, according to one embodiment, the flow learning element 520 retrieved at block 250, includes a set of two or more sub-elements. In one embodiment, the flow learning element 520 includes flow slots 522, flow pointers 524 and queue identifier 526. In some embodiments, the queue identifier 526 is optional and may not be included in the flow learning element 520. In other embodiments the queue identifier 526 identifies the queue of a background control queue of the control plane 130 which will receive a request to learn the new flow. In one embodiment, the flow slots 522 includes a set of one or more (M) slots (e.g., 4 slots) of sub-elements (e.g., reference 522A and reference 522B). Each of the slots (e.g., slot 522A) includes two parts, i.e. two sub-elements: sub-element 532 and sub-element 534. The first sub-element 532 includes an indication of whether the slot is free or used. In one embodiment, the sub-element is one bit (0 or 1) indicating that the slot 522A is being used by a flow that is currently being learnt at the forwarding device. In a non-limiting example, if the slot has already been used to store a flow identification of a packet being learnt, the 532 sub-element is set to 1. If the slot has not been used to store a flow identification of a packet being learnt, the 532 sub-element is set 0. In an alternative embodiment, 0 and 1 may be used to indicate the opposite (i.e., if a flow is being learnt, the bit is set to 0; if the flow is not being learnt, the bit is set to 1). The second sub-element 534 includes a number of bits used to store an identification of a flow being learnt. In one embodiment, the sub-element 534 includes a portion of the flow identification (e.g., hash value) of the packet.

In some embodiments, the retrieved element 520 includes additional sub-elements such as a set of one or more (M, e.g., M=4) flow pointers 524 and sub-element 526. In one embodiment, the element 520 includes for each sub-element (flow slot) 522 a corresponding flow pointer 524 comprising a pointer to a location in memory to be reserved for the addition of a new forwarding table entry in the forwarding table 150 corresponding with the flow of packets.

Referring back to block 250, upon retrieval of the element 520, the packet processing threads (e.g., 122 or 126) determines whether the flow of unknown packet being processed is already being learnt at the forwarding device based at least on whether the sub-element 534 matching a portion of the flow identification of the packet. The packet processing thread evaluate each slot in the flow learning element 520 which has a “used” bit set to determine if the flow of the packet is being learnt. In this embodiment, the packet processing thread does not evaluate or look up the slots which has a “free” bit set. In an alternative embodiment, the packet processing thread evaluates all sub-elements of the flow learning element 520 to determine whether the flow is being learnt.

In one embodiment, when the flow identification is computed with a hash function of a key associated with the packet (e.g., CRC-32), a first portion of the hash value (flow identification) is used to access the learn table and retrieve element 520 and a second portion of the hash value (flow identification) is compared with the sub-element 534 of the used slots. In a non-limiting example, the flow identification (e.g., a hash value computed with CRC-32) is 32 bits hash value, and 8 bits of these 32 bits are used to access the learn table element and 15 bits of the hash value are compared with the sub-element 534. In one embodiment, the second portion of the flow identification (e.g., 15 bits of the flow hash) is compared with each sub-element of the element 520 which has been marked as used to determine whether the flow corresponding to the packet being processed is already being learnt by the forwarding device or not. If the bits match, then either the flow is already being learnt, or the first portion of the flow identification (e.g., the first 8 bits of the CRC-32 of the packet) and the second portion of the flow identification (e.g., the following 15 bits of the CRC-32 of the packet) match with the first and second portion of another flow. However the chances of collision are very rare (i.e., the chances that the first and second portion of the flow identification of two packets belonging to two different flows collide are very rare). In one embodiment, where N is the number of flow learning elements in the flow learning table, and N is 256. In one example, 8 bits, of the hash value(flow identification) generated for a packet, are used to access an element in the flow learning tables, and 15 bits from the hash value are used to determine whether the flow learning element includes the flow identification. In this example, 23 bits in total of the flow identification are used to identify the flow to which the packet belongs. Thus, chances of 256 elements to collide in 23 bits of hash are almost impossible. Given this assumption, when the first portion of the flow identification and the second portion of the flow identification match (e.g., the first 8 bits and the following 15 bits), the packet processing thread determines that the flow is already being learnt. Alternatively if the second portion of the flow identification does not match any sub-element of the flow learning element 520 which has a “used” bit set, this means that the flow is not being learnt by the forwarding device and an entry needs to be inserted in the flow learning table 500.

When the packet processing thread (122 or 126) determines that the flow of the packet is already being learnt (i.e., the flow identification is in the flow learning table), flow moves to block 270. At block 270, the packet is forwarded by the forwarding plane 102 without sending a request to the control plane 130 to insert a new forwarding table entry in the forwarding tables 150 as the flow is already being learnt. When the flow is already being learnt, this means that a request has already been sent to the control plane by a previous packet processing thread for the same flow. In one embodiment, the packet will be processed according to a default action (e.g., the packet may be flooded, or dropped at the network device) as the forwarding table(s) may not yet include a forwarding table entry for this packet. Flow then moves to block 280. At block 280, the packet processing thread moves to processing the next packet following the forwarding of the unknown packet without being locked or stalled, even though the packet is in the process of being learnt.

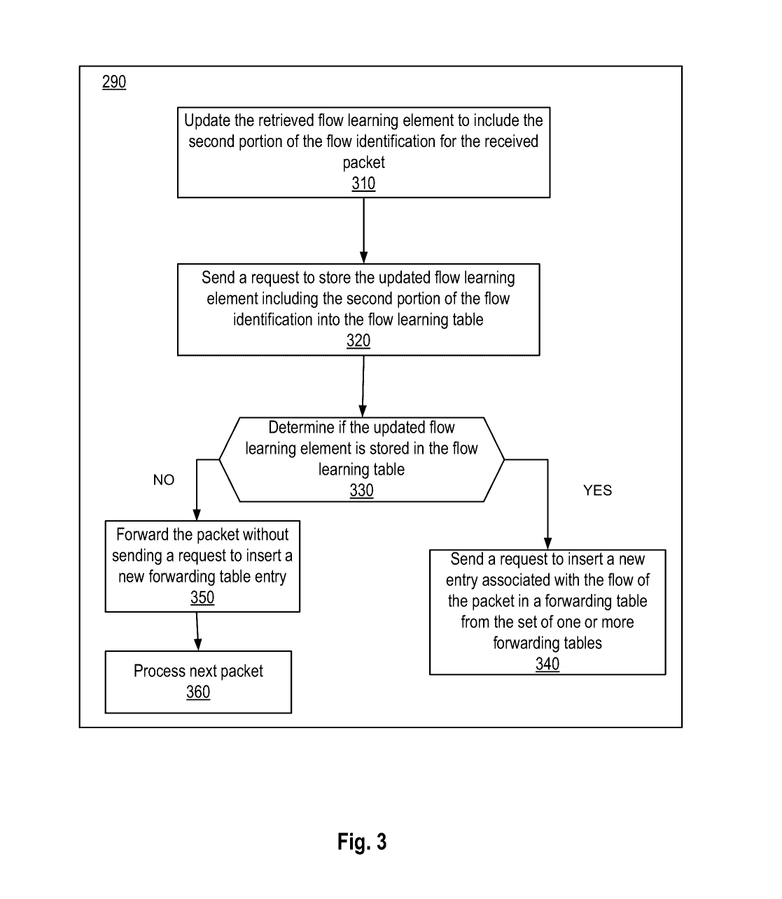

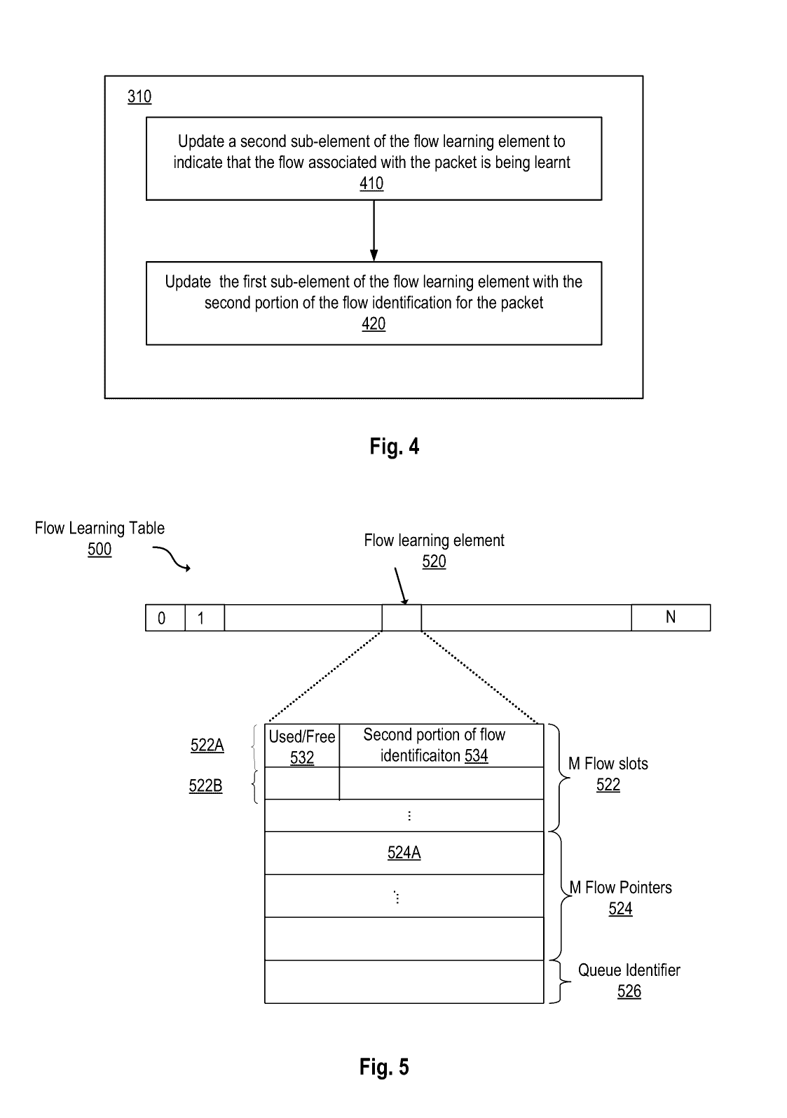

When the packet processing thread (122 or 126) determines that the flow of the packet is not being learnt (i.e., the flow identification is not in the flow learning table), flow moves to block 290. FIG. 3 illustrates a flow diagram of operations performed when the flow of an unknown packet is not being learnt yet in accordance with one embodiment. At block 310, the flow learning element 522 is updated to at least include the second portion of the flow identification in the cache memory of the packet processing thread. In one embodiment, the update is performed according to operations described at FIG. 4. FIG. 4 illustrates the update of the flow learning element associated with the unknown packet according to an embodiment of the invention. In one embodiment, a “free” slot (i.e., a slot with a free bit set (e.g., bit 532 is set to 0) is selected in the flow learning element stored in the cache memory of the packet processing thread. At block 410, the sub-element (e.g., 532) of the flow learning element 520 is updated to indicate that the flow associated with the packet is being learnt. The slot is marked used (e.g., bit 532 is set to 1). At block 420, the first sub-element of the flow learning element is updated to include the second portion of the flow identification of the packet (e.g., 15 bits of the flow identification of the packet are stored in the sub-element 534 of the flow learning element).

At block 320, a request is sent to store the updated element in the flow learning table 500. Flow then moves to block 330. In one embodiment, the packet processing thread 122 (or 126) attempts to update the element in the flow learning table by determining at block 330, whether the updated flow learning element is already stored in the flow learning table or not. The packet processing thread attempts to update the element by reserving a slot in the flow learning table using a compare and swap instruction (e.g., a 64 bits compare and swap instruction “mopcas1qs”). If the packet processing thread succeeds in reserving the slot and storing the updated flow learning element in the flow learning table, the packet processing thread may use the flow pointer fetched in fetch 32 when sending a request (block 340) to the control plane to insert to a new entry in the forwarding tables. Else the process is repeated to find, and reserve a free slot. If a free slot is reserved, another memory access is performed to get the flow pointer corresponding to reserved slot. In some embodiments, no free slot may be found, and the unknown flow is not learnt. However, as long as the control plane processes the requests to insert unknown flows in the forwarding table(s) the number of elements in the flow learning table should be less than N and free slots for new unknown flows should be found. When the updated flow learning element is stored, a request to insert a new entry associated with the flow of the packet in a forwarding table from the set of one or more forwarding tables is sent at block 340.

Referring back to block 330, if the packet processing thread does not succeed in storing the updated flow learning element in the flow learning table, flow moves to block 350. At block 350, the packet processing thread forwards the packet without sending a request to insert a new forwarding table entry in the set of one or more forwarding tables 150 and the packet processing thread processed the next packet at block 360.

In some embodiments, if two packet processing threads (e.g., packet processing thread 122 and 126) attempt to update the same element 520 in the flow learning table, only one will succeed in inserting the element as a consequence of the compare and swap instruction. In other words a new element can only be added to the table if it is not already there. This allows the processing of unknown packets of the same flow by two or more different packet processing thread, while having one request sent to the control plane for an unknown packet, and without having to stall the processing within the forwarding block 120. Flow then moves to block 340.

At block 340, a request is sent to insert a new forwarding table entry in a forwarding table for the flow associated with the packet when the updated flow learning element is stored in the flow learning table. The control plane 130 receives a request to insert a new forwarding entry associated with the unknown packet. When the control table thread is done inserting the flow in the forwarding table(s) 150, the flow is removed from the flow learning table. In one embodiment the flow is removed from the flow learning table by making its corresponding slot available. For example, the bit 532 associated with the second portion of flow identification 534 is set to 0. Further, the flow's slot index (e.g., 522A) in the flow learning table is sent in the request sent to the control plane. A new flow is allocated, and the flow pointer is set to the flow's slot, followed by a fence. At task box 9, the control plane inserts a new forwarding table entry in the forwarding tables 150.

In some embodiments, once the flow is added to one or more forwarding tables 150, it is removed from the flow learning table 140. However, in some embodiments, there may be packets of the same unknown flow that have gone past the forwarding table lookup stage in the forwarding block and which did not find their corresponding flow in any of the forwarding tables, but their processing in the forwarding block is not complete yet. Thus, if the flow learning entry corresponding to this flow is removed from the flow learning table 140, such packets may be added to the learning table 140 and may result in sending one more flow learning request to the control plane. In one embodiment, the request is dropped by the control plane 130. In an alternative embodiment, before removing the flow from the flow learning table, the forwarding element waits for all packets that were received before the flow is visible in the forwarding tables, to complete their packet processing. In this embodiment, a next packet of the same flow received at the network element will be processed according to the new entry in the one or more forwarding tables

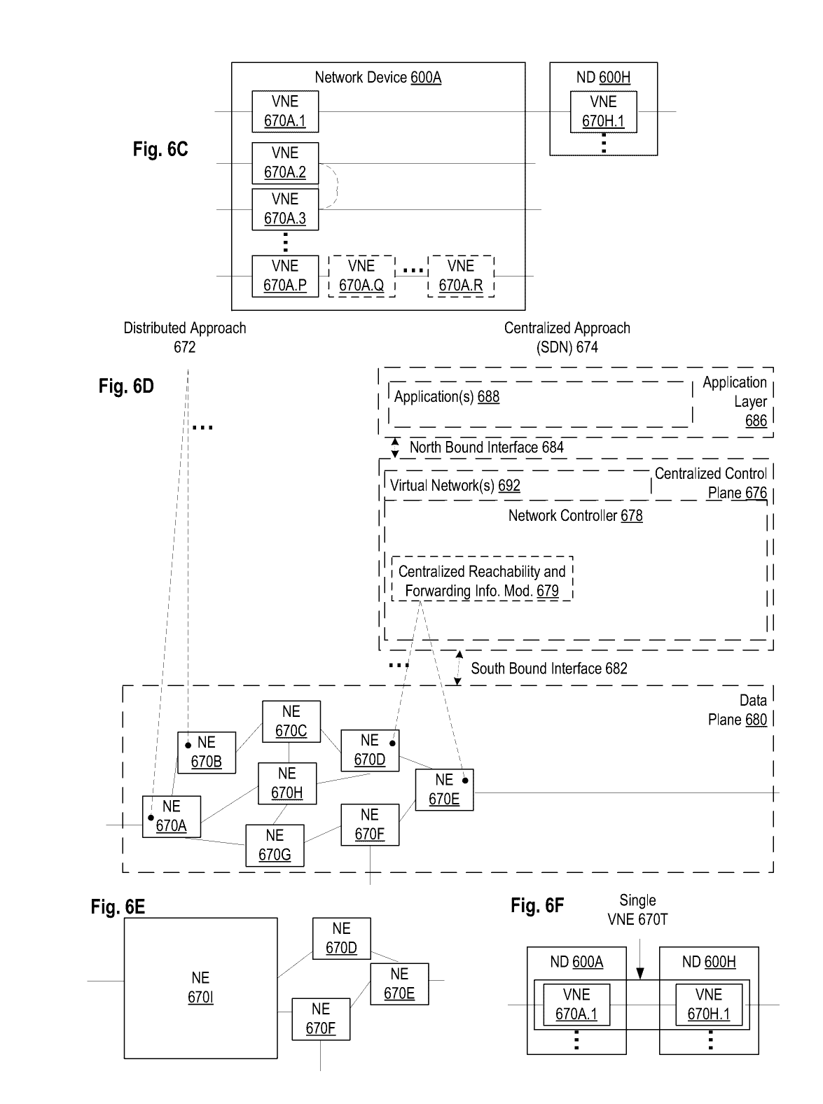

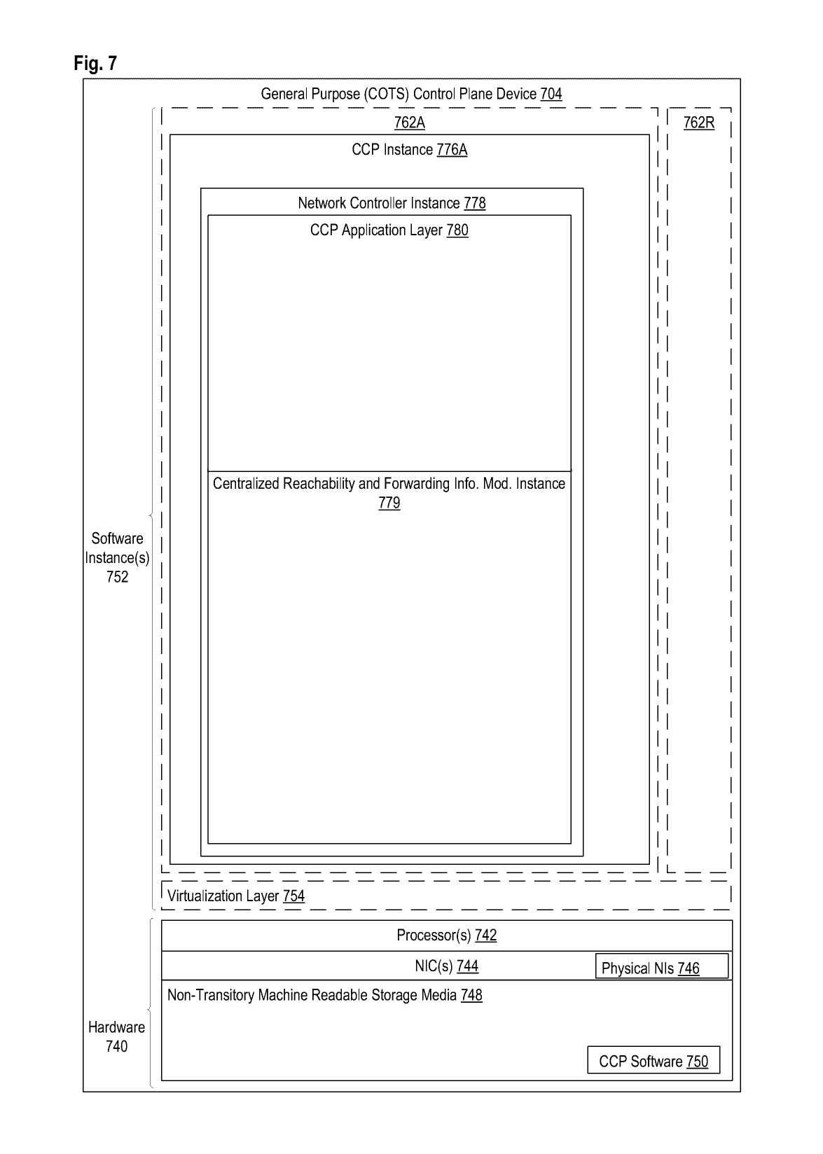

Embodiments of the invention may be performed with operations and network devices as described with reference to FIGS. 6A-6F and FIG. 7. In some embodiments, the forwarding plane described with reference to FIGS. 1-5 is included in a network device 602, 604 described below. In one embodiment the control plane 130 of described with reference to FIGS. 1-5 is included in a network device as described with reference to the figures below.

FIG. 6A illustrates connectivity between network devices (NDs) within an exemplary network, as well as three exemplary implementations of the NDs, according to some embodiments of the invention. FIG. 6A shows NDs 600A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 600A, E, and F illustrates that these NDs act as ingress and egress points for the network (and thus, these NDs are sometimes referred to as edge NDs; while the other NDs may be called core NDs).

Two of the exemplary ND implementations in FIG. 6A are: 1) a special-purpose network device 602 that uses custom application-specific integrated-circuits (ASICs) and a proprietary operating system (OS); and 2) a general purpose network device 604 that uses common off-the-shelf (COTS) processors and a standard OS.

The special-purpose network device 602 includes networking hardware 610 comprising compute resource(s) 612 (which typically include a set of one or more processors), forwarding resource(s) 614 (which typically include one or more ASICs and/or network processors), and physical network interfaces (NIs) 616 (sometimes called physical ports), as well as non-transitory machine readable storage media 618 having stored therein networking software 620. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 600A-H. During operation, the networking software 620 may be executed by the networking hardware 610 to instantiate a set of one or more networking software instance(s) 622. Each of the networking software instance(s) 622, and that part of the networking hardware 610 that executes that network software instance (be it hardware dedicated to that networking software instance and/or time slices of hardware temporally shared by that networking software instance with others of the networking software instance(s) 622), form a separate virtual network element 630A-R. Each of the virtual network element(s) (VNEs) 630A-R includes a control communication and configuration module 632A-R (sometimes referred to as a local control module or control communication module) and forwarding table(s) 634A-R, such that a given virtual network element (e.g., 630A) includes the control communication and configuration module (e.g., 632A), a set of one or more forwarding table(s) (e.g., 634A), and that portion of the networking hardware 610 that executes the virtual network element (e.g., 630A). The networking software 620 may be implemented to include embodiments of the invention and the operations described with reference to FIGS. 1-5.

The special-purpose network device 602 is often physically and/or logically considered to include: 1) a ND control plane 624 (sometimes referred to as a control plane) comprising the compute resource(s) 612 that execute the control communication and configuration module(s) 632A-R; and 2) a ND forwarding plane 626 (sometimes referred to as a forwarding plane, a data plane, or a media plane) comprising the forwarding resource(s) 614 that utilize the forwarding table(s) 634A-R and the physical NIs 616. By way of example, where the ND is a router (or is implementing routing functionality), the ND control plane 624 (the compute resource(s) 612 executing the control communication and configuration module(s) 632A-R) is typically responsible for participating in controlling how data (e.g., packets) is to be routed (e.g., the next hop for the data and the outgoing physical NI for that data) and storing that routing information in the forwarding table(s) 634A-R, and the ND forwarding plane 626 is responsible for receiving that data on the physical NIs 616 and forwarding that data out the appropriate ones of the physical NIs 616 based on the forwarding table(s) 634A-R.

FIG. 6B illustrates an exemplary way to implement the special-purpose network device 602 according to some embodiments of the invention. FIG. 6B shows a special-purpose network device including cards 638 (typically hot pluggable). While in some embodiments the cards 638 are of two types (one or more that operate as the ND forwarding plane 626 (sometimes called line cards), and one or more that operate to implement the ND control plane 624 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 636 (e.g., a first full mesh coupling the line cards and a second full mesh coupling all of the cards).

Returning to FIG. 6A, the general purpose network device 604 includes hardware 640 comprising a set of one or more processor(s) 642 (which are often COTS processors) and network interface controller(s) 644 (NICs; also known as network interface cards) (which include physical NIs 646), as well as non-transitory machine readable storage media 648 having stored therein software 650. During operation, the processor(s) 642 execute the software 650 to instantiate one or more sets of one or more applications 664A-R. While one embodiment does not implement virtualization, alternative embodiments may use different forms of virtualization—represented by a virtualization layer 654 and software containers 662A-R. For example, one such alternative embodiment implements operating system-level virtualization, in which case the virtualization layer 654 represents the kernel of an operating system (or a shim executing on a base operating system) that allows for the creation of multiple software containers 662A-R that may each be used to execute one of the sets of applications 664A-R. In this embodiment, the multiple software containers 662A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 654 represents a hypervisor (sometimes referred to as a virtual machine monitor (VMM)) or a hypervisor executing on top of a host operating system; and 2) the software containers 662A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. The software 650 may be implemented to include embodiments of the invention and the operations described with reference to FIGS. 1-5.

The instantiation of the one or more sets of one or more applications 664A-R, as well as the virtualization layer 654 and software containers 662A-R if implemented, are collectively referred to as software instance(s) 652. Each set of applications 664A-R, corresponding software container 662A-R if implemented, and that part of the hardware 640 that executes them (be it hardware dedicated to that execution and/or time slices of hardware temporally shared by software containers 662A-R), forms a separate virtual network element(s) 660A-R. The virtual network element(s) 660A-R perform similar functionality to the virtual network element(s) 630A-R—e.g., similar to the control communication and configuration module(s) 632A and forwarding table(s) 634A (this virtualization of the hardware 640 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 662A-R differently. For example, while embodiments of the invention are illustrated with each software container 662A-R corresponding to one VNE 660A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 662A-R to VNEs also apply to embodiments where such a finer level of granularity is used.

In certain embodiments, the virtualization layer 654 includes a virtual switch that provides similar forwarding services as a physical Ethernet switch. Specifically, this virtual switch forwards traffic between software containers 662A-R and the NIC(s) 644, as well as optionally between the software containers 662A-R; in addition, this virtual switch may enforce network isolation between the VNEs 660A-R that by policy are not permitted to communicate with each other (e.g., by honoring virtual local area networks (VLANs)).

The third exemplary ND implementation in FIG. 6A is a hybrid network device 606, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 602) could provide for para-virtualization to the networking hardware present in the hybrid network device 606.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 630A-R, VNEs 660A-R, and those in the hybrid network device 606) receives data on the physical NIs (e.g., 616, 646) and forwards that data out the appropriate ones of the physical NIs (e.g., 616, 646). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 6C illustrates various exemplary ways in which VNEs may be coupled according to some embodiments of the invention. FIG. 6C shows VNEs 670A.1-670A.P (and optionally VNEs 670A.Q-670A.R) implemented in ND 600A and VNE 670H.1 in ND 600H. In FIG. 6C, VNEs 670A.1-P are separate from each other in the sense that they can receive packets from outside ND 600A and forward packets outside of ND 600A; VNE 670A.1 is coupled with VNE 670H.1, and thus they communicate packets between their respective NDs; VNE 670A.2-670A.3 may optionally forward packets between themselves without forwarding them outside of the ND 600A; and VNE 670A.P may optionally be the first in a chain of VNEs that includes VNE 670A.Q followed by VNE 670A.R (this is sometimes referred to as dynamic service chaining, where each of the VNEs in the series of VNEs provides a different service—e.g., one or more layer 4-7 network services). While FIG. 6C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 6A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 6A may also host one or more such servers (e.g., in the case of the general purpose network device 604, one or more of the software containers 662A-R may operate as servers; the same would be true for the hybrid network device 606; in the case of the special-purpose network device 602, one or more such servers could also be run on a virtualization layer executed by the compute resource(s) 612); in which case the servers are said to be co-located with the VNEs of that ND.

A virtual network is a logical abstraction of a physical network (such as that in FIG. 6A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 6D illustrates a network with a single network element on each of the NDs of FIG. 6A, and within this straight forward approach contrasts a traditional distributed approach (commonly used by traditional routers) with a centralized approach for maintaining reachability and forwarding information (also called network control), according to some embodiments of the invention. Specifically, FIG. 6D illustrates network elements (NEs) 670A-H with the same connectivity as the NDs 600A-H of FIG. 6A.

FIG. 6D illustrates that the distributed approach 672 distributes responsibility for generating the reachability and forwarding information across the NEs 670A-H; in other words, the process of neighbor discovery and topology discovery is distributed.

For example, where the special-purpose network device 602 is used, the control communication and configuration module(s) 632A-R of the ND control plane 624 typically include a reachability and forwarding information module to implement one or more routing protocols (e.g., an exterior gateway protocol such as Border Gateway Protocol (BGP) (RFC 4271), Interior Gateway Protocol(s) (IGP) (e.g., Open Shortest Path First (OSPF) (RFC 2328 and 5340), Intermediate System to Intermediate System (IS-IS) (RFC 1142), Routing Information Protocol (RIP) (version 1 RFC 1058, version 2 RFC 2453, and next generation RFC 2080)), Label Distribution Protocol (LDP) (RFC 5036), Resource Reservation Protocol (RSVP) (RFC 2205, 2210, 2211, 2212, as well as RSVP-Traffic Engineering (TE): Extensions to RSVP for LSP Tunnels RFC 3209, Generalized Multi-Protocol Label Switching (GMPLS) Signaling RSVP-TE RFC 3473, RFC 3936, 4495, and 4558)) that communicate with other NEs to exchange routes, and then selects those routes based on one or more routing metrics. Thus, the NEs 670A-H (e.g., the compute resource(s) 612 executing the control communication and configuration module(s) 632A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 624. The ND control plane 624 programs the ND forwarding plane 626 with information (e.g., adjacency and route information) based on the routing structure(s). For example, the ND control plane 624 programs the adjacency and route information into one or more forwarding table(s) 634A-R (e.g., Forwarding Information Base (FIB), Label Forwarding Information Base (LFIB), and one or more adjacency structures) on the ND forwarding plane 626. For layer 2 forwarding, the ND can store one or more bridging tables that are used to forward data based on the layer 2 information in that data. While the above example uses the special-purpose network device 602, the same distributed approach 672 can be implemented on the general purpose network device 604 and the hybrid network device 606.

FIG. 6D illustrates that a centralized approach 674 (also known as software defined networking (SDN)) that decouples the system that makes decisions about where traffic is sent from the underlying systems that forwards traffic to the selected destination. The illustrated centralized approach 674 has the responsibility for the generation of reachability and forwarding information in a centralized control plane 676 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 676 has a south bound interface 682 with a data plane 680 (sometime referred to the infrastructure layer, network forwarding plane, or forwarding plane (which should not be confused with a ND forwarding plane)) that includes the NEs 670A-H (sometimes referred to as switches, forwarding elements, data plane elements, or nodes). The centralized control plane 676 includes a network controller 678, which includes a centralized reachability and forwarding information module 679 that determines the reachability within the network and distributes the forwarding information to the NEs 670A-H of the data plane 680 over the south bound interface 682 (which may use the OpenFlow protocol). Thus, the network intelligence is centralized in the centralized control plane 676 executing on electronic devices that are typically separate from the NDs.

For example, where the special-purpose network device 602 is used in the data plane 680, each of the control communication and configuration module(s) 632A-R of the ND control plane 624 typically include a control agent that provides the VNE side of the south bound interface 682. In this case, the ND control plane 624 (the compute resource(s) 612 executing the control communication and configuration module(s) 632A-R) performs its responsibility for participating in controlling how data (e.g., packets) is to be routed (e.g., the next hop for the data and the outgoing physical NI for that data) through the control agent communicating with the centralized control plane 676 to receive the forwarding information (and in some cases, the reachability information) from the centralized reachability and forwarding information module 679 (it should be understood that in some embodiments of the invention, the control communication and configuration module(s) 632A-R, in addition to communicating with the centralized control plane 676, may also play some role in determining reachability and/or calculating forwarding information—albeit less so than in the case of a distributed approach; such embodiments are generally considered to fall under the centralized approach 674, but may also be considered a hybrid approach).

While the above example uses the special-purpose network device 602, the same centralized approach 674 can be implemented with the general purpose network device 604 (e.g., each of the VNE 660A-R performs its responsibility for controlling how data (e.g., packets) is to be routed (e.g., the next hop for the data and the outgoing physical NI for that data) by communicating with the centralized control plane 676 to receive the forwarding information (and in some cases, the reachability information) from the centralized reachability and forwarding information module 679; it should be understood that in some embodiments of the invention, the VNEs 660A-R, in addition to communicating with the centralized control plane 676, may also play some role in determining reachability and/or calculating forwarding information—albeit less so than in the case of a distributed approach) and the hybrid network device 606. In fact, the use of SDN techniques can enhance the NFV techniques typically used in the general purpose network device 604 or hybrid network device 606 implementations as NFV is able to support SDN by providing an infrastructure upon which the SDN software can be run, and NFV and SDN both aim to make use of commodity server hardware and physical switches.

FIG. 6D also shows that the centralized control plane 676 has a north bound interface 684 to an application layer 686, in which resides application(s) 688. The centralized control plane 676 has the ability to form virtual networks 692 (sometimes referred to as a logical forwarding plane, network services, or overlay networks (with the NEs 670A-H of the data plane 680 being the underlay network)) for the application(s) 688. Thus, the centralized control plane 676 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 6D shows the distributed approach 672 separate from the centralized approach 674, the effort of network control may be distributed differently or the two combined in certain embodiments of the invention. For example: 1) embodiments may generally use the centralized approach (SDN) 674, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 674, but may also be considered a hybrid approach.

While FIG. 6D illustrates the simple case where each of the NDs 600A-H implements a single NE 670A-H, it should be understood that the network control approaches described with reference to FIG. 6D also work for networks where one or more of the NDs 600A-H implement multiple VNEs (e.g., VNEs 630A-R, VNEs 660A-R, those in the hybrid network device 606). Alternatively or in addition, the network controller 678 may also emulate the implementation of multiple VNEs in a single ND. Specifically, instead of (or in addition to) implementing multiple VNEs in a single ND, the network controller 678 may present the implementation of a VNE/NE in a single ND as multiple VNEs in the virtual networks 692 (all in the same one of the virtual network(s) 692, each in different ones of the virtual network(s) 692, or some combination). For example, the network controller 678 may cause an ND to implement a single VNE (a NE) in the underlay network, and then logically divide up the resources of that NE within the centralized control plane 676 to present different VNEs in the virtual network(s) 692 (where these different VNEs in the overlay networks are sharing the resources of the single VNE/NE implementation on the ND in the underlay network).

On the other hand, FIGS. 6E and 6F respectively illustrate exemplary abstractions of NEs and VNEs that the network controller 678 may present as part of different ones of the virtual networks 692. FIG. 6E illustrates the simple case of where each of the NDs 600A-H implements a single NE 670A-H (see FIG. 6D), but the centralized control plane 676 has abstracted multiple of the NEs in different NDs (the NEs 670A-C and G-H) into (to represent) a single NE 6701 in one of the virtual network(s) 692 of FIG. 6D, according to some embodiments of the invention. FIG. 6E shows that in this virtual network, the NE 6701 is coupled to NE 670D and 670F, which are both still coupled to NE 670E.

FIG. 6F illustrates a case where multiple VNEs (VNE 670A.1 and VNE 670H.1) are implemented on different NDs (ND 600A and ND 600H) and are coupled to each other, and where the centralized control plane 676 has abstracted these multiple VNEs such that they appear as a single VNE 670T within one of the virtual networks 692 of FIG. 6D, according to some embodiments of the invention. Thus, the abstraction of a NE or VNE can span multiple NDs.

While some embodiments of the invention implement the centralized control plane 676 as a single entity (e.g., a single instance of software running on a single electronic device), alternative embodiments may spread the functionality across multiple entities for redundancy and/or scalability purposes (e.g., multiple instances of software running on different electronic devices).

Similar to the network device implementations, the electronic device(s) running the centralized control plane 676, and thus the network controller 678 including the centralized reachability and forwarding information module 679, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 7 illustrates, a general purpose control plane device 704 including hardware 740 comprising a set of one or more processor(s) 742 (which are often COTS processors) and network interface controller(s) 744 (NICs; also known as network interface cards) (which include physical NIs 746), as well as non-transitory machine readable storage media 748 having stored therein centralized control plane (CCP) software 750.

In embodiments that use compute virtualization, the processor(s) 742 typically execute software to instantiate a virtualization layer 754 and software container(s) 762A-R (e.g., with operating system-level virtualization, the virtualization layer 754 represents the kernel of an operating system (or a shim executing on a base operating system) that allows for the creation of multiple software containers 762A-R (representing separate user space instances and also called virtualization engines, virtual private servers, or jails) that may each be used to execute a set of one or more applications; with full virtualization, the virtualization layer 754 represents a hypervisor (sometimes referred to as a virtual machine monitor (VMM)) or a hypervisor executing on top of a host operating system, and the software containers 762A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 750 (illustrated as CCP instance 776A) is executed within the software container 762A on the virtualization layer 754. In embodiments where compute virtualization is not used, the CCP instance 776A on top of a host operating system is executed on the “bare metal” general purpose control plane device 704. The instantiation of the CCP instance 776A, as well as the virtualization layer 754 and software containers 762A-R if implemented, are collectively referred to as software instance(s) 752.

In some embodiments, the CCP instance 776A includes a network controller instance 778. The network controller instance 778 includes a centralized reachability and forwarding information module instance 779 (which is a middleware layer providing the context of the network controller 678 to the operating system and communicating with the various NEs), and an CCP application layer 780 (sometimes referred to as an application layer) over the middleware layer (providing the intelligence required for various network operations such as protocols, network situational awareness, and user—interfaces). At a more abstract level, this CCP application layer 780 within the centralized control plane 676 works with virtual network view(s) (logical view(s) of the network) and the middleware layer provides the conversion from the virtual networks to the physical view.

The centralized control plane 676 transmits relevant messages to the data plane 680 based on CCP application layer 780 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 680 may receive different messages, and thus different forwarding information. The data plane 680 processes these messages and programs the appropriate flow information and corresponding actions in the forwarding tables (sometime referred to as forwarding tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 680, the packet (or a subset of the packet header and content) is typically forwarded to the centralized control plane 676. The centralized control plane 676 will then program forwarding table entries into the data plane 680 to accommodate packets belonging to the flow of the unknown packet. Once a specific forwarding table entry has been programmed into the data plane 680 by the centralized control plane 676, the next packet with matching credentials will match that forwarding table entry and take the set of actions associated with that matched entry. In embodiments of the invention, when an unknown packet is received, the data plane 680 is configured to process the unknown packet according to the operations described with reference to the block diagrams and flow diagrams of FIGS. 1-5.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used—for instance, in a connectionless network, Equal Cost Multi Path (ECMP) (also known as Equal Cost Multi Pathing, multipath forwarding and IP multipath) (RFC 2991 and 2992) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1 Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking). For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

A virtual circuit (VC), synonymous with virtual connection and virtual channel, is a connection oriented communication service that is delivered by means of packet mode communication. Virtual circuit communication resembles circuit switching, since both are connection oriented, meaning that in both cases data is delivered in correct order, and signaling overhead is required during a connection establishment phase. Virtual circuits may exist at different layers. For example, at layer 4, a connection oriented transport layer datalink protocol such as Transmission Control Protocol (TCP) (RFC 793 and 1180) may rely on a connectionless packet switching network layer protocol such as IP, where different packets may be routed over different paths, and thus be delivered out of order. Where a reliable virtual circuit is established with TCP on top of the underlying unreliable and connectionless IP protocol, the virtual circuit is identified by the source and destination network socket address pair, i.e. the sender and receiver IP address and port number. However, a virtual circuit (RFC 1180, 955, and 1644) is possible since TCP includes segment numbering and reordering on the receiver side to prevent out-of-order delivery. Virtual circuits are also possible at Layer 3 (network layer) and Layer 2 (datalink layer); such virtual circuit protocols are based on connection oriented packet switching, meaning that data is always delivered along the same network path, i.e. through the same NEs/VNEs. In such protocols, the packets are not routed individually and complete addressing information is not provided in the header of each data packet; only a small virtual channel identifier (VCI) is required in each packet; and routing information is transferred to the NEs/VNEs during the connection establishment phase; switching only involves looking up the virtual channel identifier in a table rather than analyzing a complete address. Examples of network layer and datalink layer virtual circuit protocols, where data always is delivered over the same path: X.25, where the VC is identified by a virtual channel identifier (VCI); Frame relay, where the VC is identified by a VCI; Asynchronous Transfer Mode (ATM), where the circuit is identified by a virtual path identifier (VPI) and virtual channel identifier (VCI) pair; General Packet Radio Service (GPRS); and Multiprotocol label switching (MPLS) (RFC 3031), which can be used for IP over virtual circuits (Each circuit is identified by a label).

Certain NDs (e.g., certain edge NDs) use a hierarchy of circuits. The leaf nodes of the hierarchy of circuits are subscriber circuits. The subscriber circuits have parent circuits in the hierarchy that typically represent aggregations of multiple subscriber circuits, and thus the network segments and elements used to provide access network connectivity of those end user devices to the ND. These parent circuits may represent physical or logical aggregations of subscriber circuits (e.g., a virtual local area network (VLAN), a permanent virtual circuit (PVC) (e.g., for Asynchronous Transfer Mode (ATM)), a circuit-group, a channel, a pseudo-wire, a physical NI of the ND, and a link aggregation group). A circuit-group is a virtual construct that allows various sets of circuits to be grouped together for configuration purposes, for example aggregate rate control. A pseudo-wire is an emulation of a layer 2 point-to-point connection-oriented service. A link aggregation group is a virtual construct that merges multiple physical NIs for purposes of bandwidth aggregation and redundancy. Thus, the parent circuits physically or logically encapsulate the subscriber circuits.

Each VNE (e.g., a virtual router, a virtual bridge (which may act as a virtual switch instance in a Virtual Private LAN Service (VPLS) (RFC 4761 and 4762) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some NDs provide support for VPLS (Virtual Private LAN Service) (RFC 4761 and 4762). For example, in a VPLS network, end user devices access content/services provided through the VPLS network by coupling to CEs, which are coupled through PEs coupled by other NDs. VPLS networks can be used for implementing triple play network applications (e.g., data applications (e.g., high-speed Internet access), video applications (e.g., television service such as IPTV (Internet Protocol Television), VoD (Video-on-Demand) service), and voice applications (e.g., VoIP (Voice over Internet Protocol) service)), VPN services, etc. VPLS is a type of layer 2 VPN that can be used for multi-point connectivity. VPLS networks also allow end use devices that are coupled with CEs at separate geographical locations to communicate with each other across a Wide Area Network (WAN) as if they were directly attached to each other in a Local Area Network (LAN) (referred to as an emulated LAN).

In VPLS networks, each CE typically attaches, possibly through an access network (wired and/or wireless), to a bridge module of a PE via an attachment circuit (e.g., a virtual link or connection between the CE and the PE). The bridge module of the PE attaches to an emulated LAN through an emulated LAN interface. Each bridge module acts as a “Virtual Switch Instance” (VSI) by maintaining a forwarding table that maps MAC addresses to pseudowires and attachment circuits. PEs forward frames (received from CEs) to destinations (e.g., other CEs, other PEs) based on the MAC destination address field included in those frames.

For example, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method of flow learning in a network device, the method comprising:
receiving (210), by the network device, a packet of a flow of packets;
determining (240), based on an identification of the flow of the packet, whether the packet has a corresponding forwarding table entry within a set of one or more forwarding tables of the network device;
responsive to determining that the packet does not have any corresponding forwarding table entry, retrieving (250) a flow learning element from a flow learning table using a first portion of the flow identification;
determining whether the flow of the packet is being learnt by the network device, based at least on a second portion of the flow identification for the received packet matching a sub-element of the retrieved flow learning element;
responsive to determining that the flow is being learnt, forwarding (270) the packet without sending a request to insert a new entry in one of the set of one or more forwarding tables; and
responsive to determining that the flow is not yet being learnt, performing the following:
updating (310) the retrieved flow learning element to include the second portion of the flow identification,
sending (320) a request to store the updated flow learning element into the flow learning table, and
responsive to determining that the updated flow learning element is stored in the flow learning table, sending (340) a request to insert a new entry associated with the flow of the packet in a forwarding table from the set of one or more forwarding tables.

2. The method of claim 1, further comprising responsive to determining that the updated flow learning element is not stored in the flow learning table, forwarding the packet without sending a request to insert a new entry associated with the flow of the packet in one of the set of one or more forwarding tables.

3. The method of claim 1, further comprising mapping (220) the packet to a packet processing thread.

4. The method of claim 1, wherein the method further comprises generating (230) the flow identification for the received packet based on a key associated with the flow of packets.

5. The method of claim 4, wherein generating the flow identification includes generating a hash value using a hashing function.

6. The method of claim 5, wherein the first portion of the flow identification is a first portion of the hash value, and the second portion of the flow identification is a second portion of the hash value that is disjoint from the first portion.

7. The method of claim 1, wherein the sub-element of the flow learning element is a first sub-element and wherein the updating the retrieved flow learning element further comprises:
updating (410) the first sub-element of the flow learning element with the second portion of the hash value; and
updating (420) a second sub-element of the flow learning element to indicate that the flow associated with the packet is being learnt.

8. The method of claim 1, wherein determining that the updated flow learning element is stored in the flow learning table comprises determining that the element has not been updated and stored for another packet of the same flow after being retrieved from the flow learning table for the packet.

9. The method of claim 1, wherein forwarding the packet includes one of dropping the packet, and flooding the packet.

10. The method of claim 1, wherein sending a request to store the updated flow learning element is performed with an atomic compare and swap instruction.

11. A non-transitory machine-readable storage medium (618, 648) that provides instructions, which when executed by a processor (612, 642) of a network device, cause said processor to perform operations comprising:
receiving (210), by the network device, a packet of a flow of packets;
determining (240), based on an identification of the flow, whether the packet has a corresponding forwarding table entry within a set of one or more forwarding tables of the network device;
responsive to determining that the packet does not have any corresponding forwarding table entry, retrieving (250) a flow learning element from a flow learning table using a first portion of the flow identification;
determining whether the flow of the packet is being learnt by the network device, based at least on a second portion of the flow identification for the received packet matching a sub-element of the retrieved flow learning element;
responsive to determining that the flow is being learnt, forwarding (270) the packet without sending a request to insert a new entry in one of the set of one or more forwarding tables; and
responsive to determining that the flow is not yet being learnt performing the following:
updating (310) the retrieved flow learning element to include the second portion of the flow identification,
sending (320) a request to store the updated flow learning element into the flow learning table, and
responsive to determining that the updated flow learning element is stored in the flow learning table, sending (340) a request to insert a new entry associated with the flow of the packet in a forwarding table from the set of one or more forwarding tables.

12. The non-transitory machine-readable storage medium (618, 648) of claim 11, wherein the operations further comprise responsive to determining that the updated flow learning element is not stored in the flow learning table, forwarding the packet without sending a request to insert a new entry associated with the flow of the packet in one of the set of one or more forwarding tables.

13. The non-transitory machine-readable storage medium (618, 648) of claim 11, wherein the operations further comprise mapping (220) the packet to a packet processing thread.

14. The non-transitory machine-readable storage medium (618, 648) of claim 11, wherein the operations further comprise generating (230) the flow identification for the received packet based on a key associated with the flow of packets.

15. The non-transitory machine-readable storage medium (618, 648) of claim 14, wherein generating the flow identification includes generating a hash value using a hashing function.

16. The non-transitory machine-readable storage medium (618, 648) of claim 15, wherein the first portion of the flow identification is a first portion of the hash value, and the second portion of the flow identification is a second portion of the hash value that is disjoint from the first portion.

17. The non-transitory machine-readable storage medium (618, 648) of claim 11, wherein the sub-element of the flow learning element is a first sub-element and wherein the updating the retrieved flow learning element further comprises:
updating (410) the first sub-element of the flow learning element with the second portion of the hash value; and
updating (420) a second sub-element of the flow learning element to indicate that the flow associated with the packet is being learnt.

18. The non-transitory machine-readable storage medium (618, 648) of claim 11, wherein determining that the updated flow learning element is stored in the flow learning table comprises determining that the element has not been updated and stored for another packet of the same flow after being retrieved from the flow learning table for the packet.

19. The non-transitory machine-readable storage medium (618, 648) of claim 11, wherein forwarding the packet includes one of dropping the packet, and flooding the packet.

20. The non-transitory machine-readable storage medium (618, 648) of claim 11, wherein sending a request to store the updated flow learning element is performed with an atomic compare and swap instructions.
